(19) United States
(12) Patent Application Publication
(10) Pub. No.: US 2008/0275790 A1
(43) Pub. Date: Nov. 6, 2008

(54) BID GROUPS FOR ONLINE AUCTIONS

(76) Inventor: Tom Campbell, Bellevue, WA (US)

Correspondence Address: STRATEGIC PATENTS P.C.., C/O PORTFOLIOIP, P.O. BOX 52050, MINNEAPOLIS, MN, 55402, US

(21) Appl. No.: 12/115,183

(22) Filed: May 5, 2008

Related U.S. Application Data
(60) Provisional application No. 60/915,768, filed on May 3, 2007.

(51) Int. Cl. G06Q 30/00

(52) U.S. Cl. 705/26

(57) ABSTRACT

Described herein are systems and methods for providing an automated bid proxy for online auctions that manages multiple, concurrent bids. The proxy transmits a user-defined group of bids to an online auction system in a manner that reallocates bids around a target bid time to accommodate limitations of the proxy system, a target auction system, network limitations, and so forth. At the same time, the bids are allocated in a manner that aims to ensure that all bids are placed before a target bid time. Upon the placement of a specified number of winning bids, the proxy may also terminate all remaining bids. By allowing the user to bid on more items than he is interested in buying, this arrangement of automatic bids into an automatically terminating bid group allows a user to improve his chances of purchasing a specified quantity of items at or below a desired price.

### RELATED APPLICATIONS

This application claims the benefit of U.S. application No. 60/915,768 filed on May 3, 2007, the entire content of which is hereby incorporated by reference.

### BACKGROUND

1. Field

The invention relates to electronic commerce, and more particularly to grouping together bids for participating in online auctions.

2. Description of the Related Art

Online auctions provide a convenient medium for sale and resale of goods and services, and have grown rapidly in popularity. As popularity has grown, auction participants have become savvier about the competitive bidding process. For example, the technique of “sniping” has emerged, in which a participant places a single, last-minute (or last-second) bid. This technique aims to achieve tactical advantage by avoiding price run-ups that might result from numerous bidders who constantly seek to outbid one another.

In certain instances, user may wish to acquire a number of interchangeable products using a bidding strategy that places bids on more items that the user wishes to acquire, while also employing sniping techniques. There remains a need for an automated bid proxy that allows a user to manage a group of bids.

### SUMMARY

Described herein are systems and methods for providing an automated bid proxy for online auctions that manages multiple, concurrent bids. The proxy transmits a user-defined group of bids to an online auction system in a manner that reallocates bids around a target bid time to accommodate limitations of the proxy system, a target auction system, network limitations, and so forth. At the same time, the bids are allocated in a manner that aims to ensure that all bids are placed before a target bid time. Upon the placement of a specified number of winning bids, the proxy may also terminate all remaining bids. By allowing the user to bid on more items than he is interested in buying, this arrangement of automatic bids into an automatically terminating bid group allows a user to improve his chances of purchasing a specified quantity of items at or below a desired price.

In one aspect, a method disclosed herein includes receiving a user specification of a group bid for an item, the group bid including a total number of bids to be placed, a target number of winning bids; and a preferred bid time; creating a bid schedule including a plurality of bids each having a bid time, wherein the plurality of bids allocate the total number of bids over a time period selected to ensure that bid placement does not exceed a capacity of an automated bid proxy and selected to ensure that the total number of bids can be placed on or before the preferred bid time; and submitting the plurality of bids from the automated bid proxy to an online auction system at the bid times specified in the bid schedule.

The method may include terminating the step of submitting the plurality of bids when the target number of winning bids has been achieved. The method may include cancelling any remaining bids in the bid schedule when the target number of winning bids has been achieved. The method may include allocating the plurality of bids in the bid schedule over a time period selected to ensure that bid placement does not exceed a capacity of the online auction system. The method may include allocating the plurality of bids in the bid schedule over a time period selected to ensure that bids from the automated bid proxy to the online auction system arrive at the online auction system at or before the preferred bid time. The method may include submitting bids to a plurality of online auction systems for the item. The user specification may include a bid price. The user specification may include a range of bid prices. The method may include determining the bid schedule using a histogram that characterizes a time distribution for bids. The method may include staggering the total number of bids to be placed over a time interval according to the histogram. The method may include adjusting each one of the bid times by an offset. The offset may account for one or more of network latency and network traffic. The offset may account for a measured network performance. The offset may account for an anticipated network performance.

In another aspect, a computer program product disclosed herein includes computer executable code that, when executing on one or more computing devices, performs the steps of: receiving a user specification of a group bid for an item, the group bid including a total number of bids to be placed, a target number of winning bids; and a preferred bid time; creating a bid schedule including a plurality of bids each having a bid time, wherein the plurality of bids allocate the total number of bids over a time period selected to ensure that bid placement does not exceed a capacity of an automated bid proxy and selected to ensure that the total number of bids can be placed on or before the preferred bid time; and submitting the plurality of bids from the automated bid proxy to an online auction system at the bid times specified in the bid schedule.

The computer program product may include computer executable code that performs the step of submitting the plurality of bids when the target number of winning bids has been achieved. The computer program product may include computer executable code that performs the step of cancelling any remaining bids in the bid schedule when the target number of winning bids has been achieved. The computer program product may include computer executable code that performs the step of staggering the total number of bids to be placed over a time interval according to a histogram that characterizes a time distribution for bids. The computer program product may include computer executable code that performs the step of adjusting each one of the bid times by an offset. The offset may account for one or more of network latency and network traffic.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an embodiment of a system in which an automated bid proxy automatically places auction bids.

FIG. 2 shows a bid table data structure.

FIG. 3 shows a bid group data structure.

FIG. 4 depicts a method for processing an order containing multiple bids.

FIG. 5 depicts an embodiment of the automated bid proxy.

FIG. 6 depicts a logical flow diagram of a master control method for providing an automated bid proxy service.

FIG. 7 depicts a logical flow diagram of a bid counting method.

FIG. 8 shows a histogram data structure.

FIG. 9 shows an active bid table data structure.

FIG. 10 depicts a logical flow diagram of a bid queuing method.

FIG. 11 depicts an adjusted bid table data structure.

FIG. 12 depicts a method for calculating a bid offset value.

FIG. 13 depicts a method for calculating a bid stagger value.

FIG. 14 depicts a logical flow diagram of a bid execution method.

FIG. 15 depicts a method for preventing and/or canceling superfluous bids.

### DETAILED DESCRIPTION

Systems and methods of the present invention provide time-dependent bidding services. In embodiments, these services may be directed at placing timed bids in online auction venues. One form of timed bid may be a “snipe,” which is placed just before the end of an auction so that other bidders do not have a chance to place a counter-bid. The action of placing such a timed bid may be referred to as “sniping.” In any case, systems and methods of the present invention may enable a user to specify a “bid group,” which may comprise a set of bids and a desired number of winning bids, wherein the desired number may be less than the total number of bids in the set. Embodiments of the present invention may place any and all of the bids in the set while keeping track of the number of those bids that win. Once this number equals the desired number, all of the remaining bids are cancelled or at least no more bids are made. The systems and methods herein advantageously distribute bids about a desired bid time in order to accommodate physical limitations of a system placing the bid and the system receiving the bid, while seeking to ensure that all bids are placed before a specified bid time.

It will be appreciated that the techniques described herein may have wider applicability, such as to other systems where an automatic, last-minute or last-second bid or action is desirable, such as computerized trading in equities, derivatives, or other financial instruments.

It will also be appreciated that the following description emphasizes operation of an automated bid proxy and the manner in which such an automated bid proxy distributes bids to achieve various objectives. Numerous techniques including web interfaces and the like are known and may be suitably employed to provide a user interface for a user to configure a group bid and provide data used by the systems and methods below to execute bids. Similarly, an administrative interface may be provided to control and manage those features that are not exposed to a user. By way of example and not of limitation, the histogram described below for distributing bids around a desired bid time may be configured by a system administrator using empirical, statistical, or other techniques independent of the user interface. Various options for implementing these features are well known in the art, and for purposes of clarity and focus these features are not described below in detail. However, all aspects of the systems and methods described herein, including various user inputs and outputs, administrator inputs and outputs, and so forth are intended to fall within the scope of this disclosure.

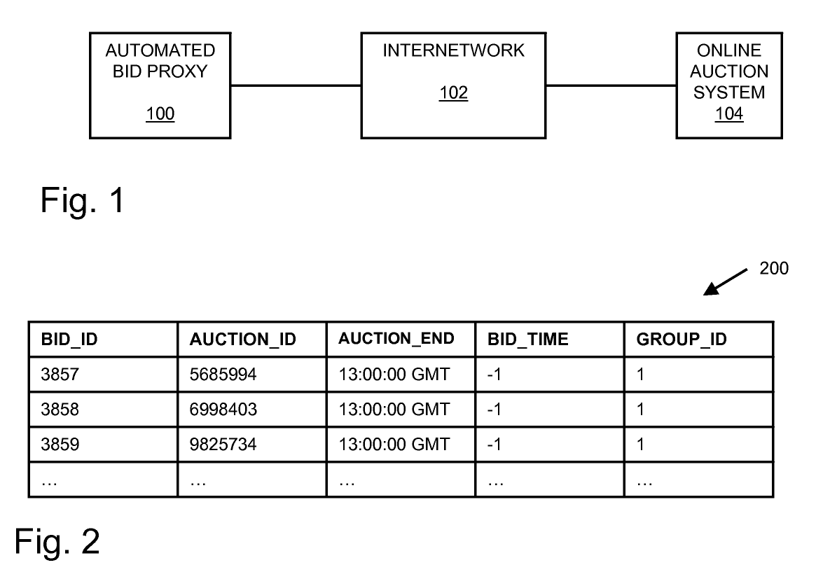

Referring now to FIG. 1, an embodiment of a system is shown. In this system, an automated bid proxy 100 may automatically place auction bids at an online auction system 104 through an internetwork 102 such as the Internet.

The automated bid proxy 100 may include a server computer, such as a Dell PowerEdge rack server. The server may include a hard drive, RAM, CPU, and a network interface for coupling the automated bid proxy 100 to the internetwork 102. In embodiments, the automated bid proxy 100 may reside behind a firewall. The automated bid proxy 100 may include multiple server computers arranged in a clustered, replicated, or distributed configuration. The server may include an operating system, such as a variant of the UNIX operating system. In a distributed configuration, the automated bid proxy 100 may include a plurality of server computers connected via one or more public and/or private data networks, wherein the servers are located in one or more geographic locations. It will be appreciated that there is an intrinsic communications lag between servers and that this lag increases as the intervening physical distance increases.

The online auction system 104 may include a server computer, such as a Dell PowerEdge rack server. The server may include a hard drive, RAM, CPU, and a network interface for coupling the online auction system 104 to the internetwork 102. In embodiments, the online auction system 104 may further include a firewall and/or load balancer behind which the server computer may reside. The online auction system 104 may include multiple server computers arranged in a clustered, replicated, or distributed configuration. The online auction system 104 may provide an online auction service, in which an item may be provided for sale in an auction format, with bids accepted electronically via the internetwork 102. The auction may be identified by a unique auction identifier and may have an end time at which the auction closes, as well as other characteristics such as a minimum bid, and instant winning bid, item descriptions, and so forth. One popular online auction system 104 is eBay, however other online auction platforms exist, and the automated bidding systems described herein may be suitably adapted to use with any such auction platform having a Web or other network interface. In an embodiment, the automated bid proxy 100 is configured to distribute bids across a number of different online auction platforms. Thus for example, a group bid as described in greater detail below may be distributed in any suitable fashion among several different online auction facilities where a desired product is being sold.

The automated bid proxy 100 may communicate with the online auction system 104, such as through standardized protocols and formats such as HTTP requests and/or responses, XML, HTML, and the like, or through proprietary formats, as well as combinations of the foregoing. In embodiments, the automated bid proxy 100 may perform screen scraping on web pages that are provided by the auction system 104, such as to obtain information for formulating bids or interpreting results thereof, or the automated bid proxy 100 may directly interpret communications from the online auction system 104 without any need to reconstruct or interpret rendered HTML or the like contained therein. However interpreted, data in these communications may be employed by the automated bid proxy 100 to determine additional steps. For example and without limitation, from time to time, the automated bid proxy 100 may request and receive information from the auction system 104, the information indicating the time at which an auction will close and the current highest bid in the auction. Perhaps in response to this information, the bid proxy 100 may transmit a signal, such as a data packet or set of data packets, to the online auction system 104 via the internetwork 102, such as to initiate or revise a bid, or engage in other bidding-related activity.

Referring now to FIG. 2, a bid table 200 may include entries relating to the unique auction identifier (AUCTION_ID) of an auction, the end time of the auction (AUCTION_END), a desired bid time (BID_TIME), and a bid group identifier (GROUP_ID). Each column in the bid table 200 may be associated with a snipe order that specifies a bid to be placed at some point in the future. The desired bid time may be expressed as a delta, in whole seconds or some other unit of time, from the end time. Typically, the desired bid time precedes the end time of the auction (i.e., less than or equal to −1 (second)); however in various embodiments other values may be stored in this field to encode control information or the like for execution or other handling by the automated bid proxy 100. The bid group identifier may allow any number of bids to be grouped together in a single snipe order. This order may be associated with an integer, which is the bid group identifier.

The bid table 200 may be implemented in the automated bid proxy 100 as a flat file. The bid table may contain any number of rows, each of which may be representative of a future bid. In alternate embodiments, the bid table 200 may be implemented in the automated bid proxy 100 as an XML file, a table in a relational database, a data structure in the RAM of the server, and so forth. Also in alternate embodiments, some or all of the end times appearing in the bid table 200 may be offset by a constant or variable value from the actual end times of the auctions at the online auction system 104. This offset may compensate for intrinsic lags or delays introduced by the automated bid proxy 100, the internetwork 102, and/or the online auction system 104.

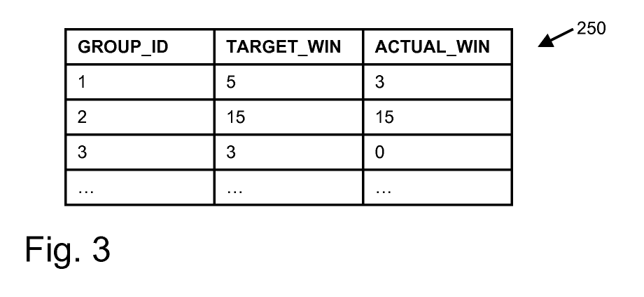

Referring now to FIG. 3, a bid group table 250 may include entries relating the bid group identifier (GROUP_ID) with a specified number of winning bids (TARGET_WIN) and an actual number of winning bids (ACTUAL_WIN).

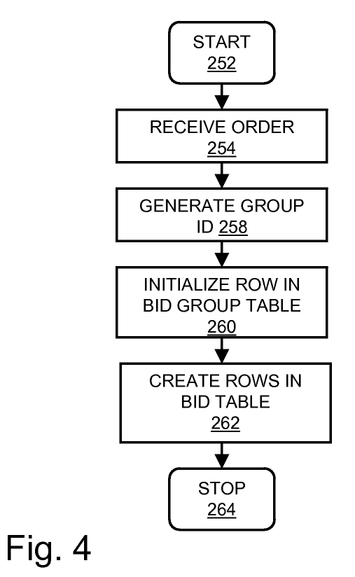

Referring now to FIG. 4, the bid group table 250 may be modified by the bid proxy 100 according to the depicted process. Starting at step 252, processing flow continues to step 254, where the bid proxy 100 receives a snipe order comprising a plurality of bids. Then, the process may continue to step 258, where a new GROUP_ID may be assigned to that order. Next, the process may continue to step 260, where a row in the bid group table 250 is initialized for that GROUP_ID: the row is created; the TARGET_WIN value in that row may be set to a specified value; and the ACTUAL_WIN value in that row may be set to zero or any other appropriate value. Processing flow may then continue to step 262 where the proxy 100 may create a plurality of rows in the bid table 200, one for each bid of the plurality of bids. Finally, the process may stop, as indicated by step 264.

The following description of the automated bid proxy 100 is provided for the purpose of illustration and not limitation. Many other embodiments of the automated bid proxy 100 will be appreciated and all such embodiments are within the scope of the present disclosure. In particular, the automated bid proxy 100 that is described hereinafter contains features that are directed at staggering bids so as to spread out associated server and networks loads. While this could be a beneficial feature in practice, it may not be required to practice the present invention.

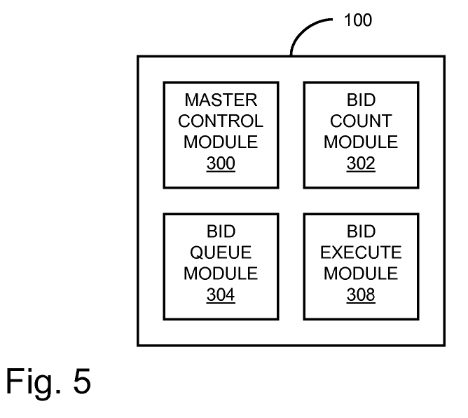

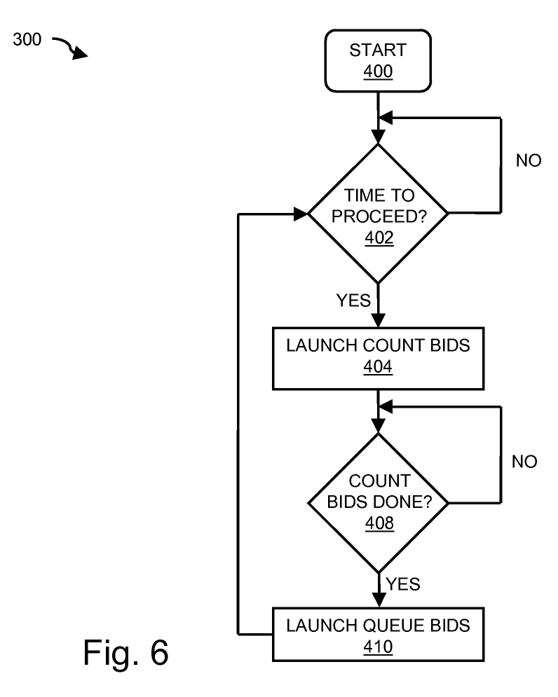

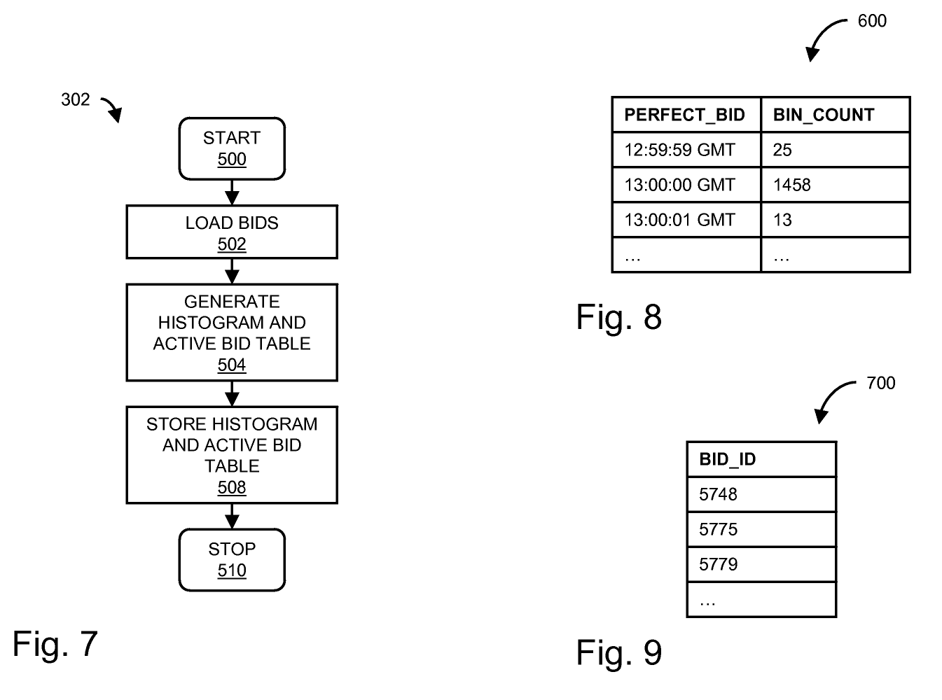

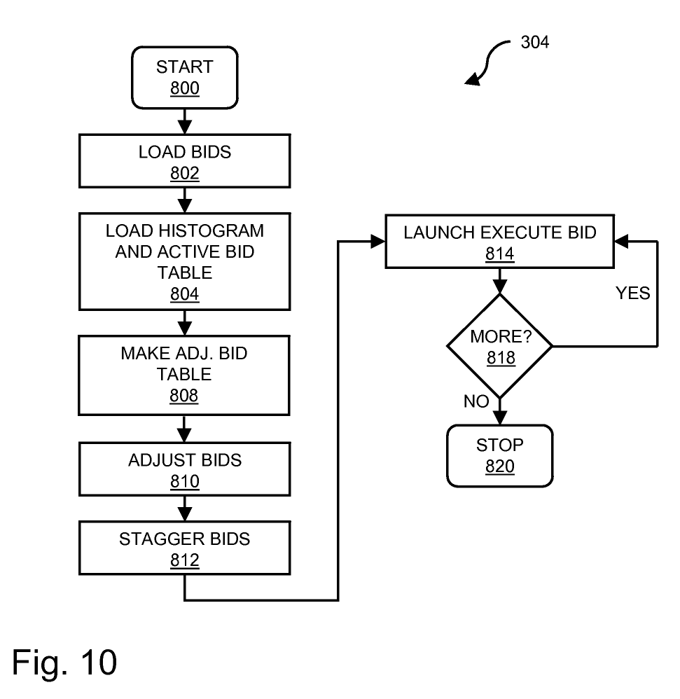

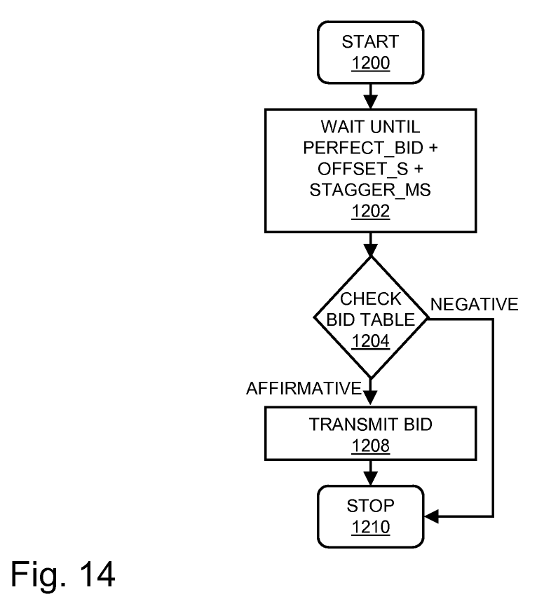

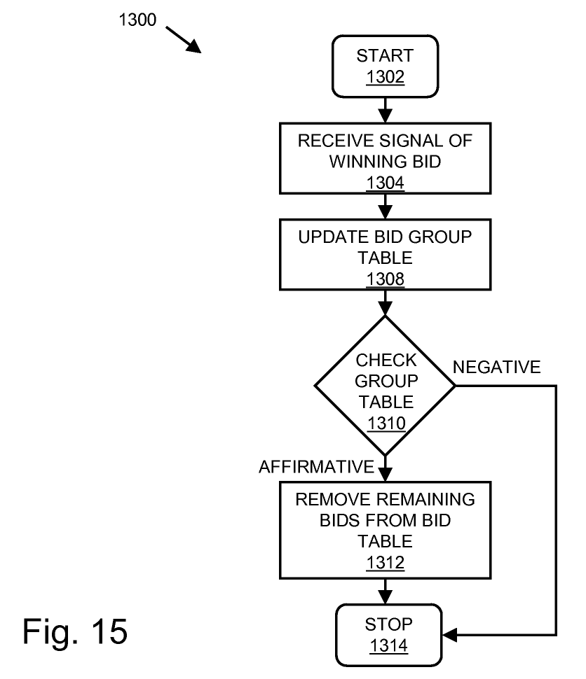

Referring now to FIG. 5, the automated bid proxy 100 may include a number of software modules, which may be implemented as computer programs and which may be instantiated as computer processes on the server of the automated bid proxy 100. These software modules may include a master control module 300, a bid count module 302, a bid queue module 304, and a bid execute module 308. When the automated bid proxy 100 is initially powered-up or started, an instance of the master control process 300 may be automatically instantiated. As will be appreciated from the following discussion, the instance of the master control process 300 may run at all times, while instances of the other modules 302, 304, 308 may run periodically or from time to time. A method of the master control process 300 is described in detail hereinafter with reference to FIG. 6. Operation of an embodiment of the bid count module 302 is described in detail hereinafter with reference to FIG. 7. Operation of an embodiment of the bid queue module 304 is described in detail hereinafter with reference to FIG. 10. Operation of an embodiment of the bid execute module 308 is described in detail hereinafter with reference to FIG. 14.

Referring now to FIG. 6, operation of the master control module 300 may start at step START 400. From there, processing flow may continue to step 402, where a test may be conducted to determine whether it is time to launch some of the bid times in the bid table 200. In an embodiment, the time to dynamically adjust some of the bid times occurs approximately every 45 seconds. If the result of the test at block 402 is negative, processing flow may return to step 402, where the test is repeated. Otherwise, processing flow may proceed to step LAUNCH COUNT BIDS 404. Here the bid count module 302 may be instantiated, yielding an instance of the bid count module 302. The instance of the bid count module 302 may operate for a finite amount of time and then exit. In the meantime and without delay, processing flow may continue to the step 408, where a test may be conducted to determine if the instance of the bid count module 302 has exited. If the result of this test is negative, processing flow may return to step 408, where this test may be repeated. Otherwise, processing flow may continue to step LAUNCH QUEUE BIDS 410. Here the bid queue module 304 may be instantiated, yielding an instance of the bid queue module 304. Having instantiated the bid queue module 304, processing flow may immediately return to step 402, from which the method of the master control module 300 may continue ad infinitum.

Referring now to FIG. 7, operation of the bid count module 302 may start at step START 500. From there, processing flow may continue to step 502, where the bid table 200 may be loaded into a region of memory associated with and accessible to the instance of the bid count module 302. Then, processing flow may continue to step 504, where a histogram 600 and an active bid table 700 may be generated from the data in the bid table 200. An embodiment of the histogram 600 is described in detail hereinafter with reference to FIG. 8. An embodiment of the active bid table is described in detail hereinafter with reference to FIG. 9. Methods of generating the histogram 600 and the active bid table 700 will be apparent to those of skill in the art. Next, processing flow may continue to step STORE HISTOGRAM AND ACTIVE BID TABLE 508, where the histogram 600 and active bid table 700 may be stored in the automatic bid proxy 100, for example as one or more flat files on a disk drive. In alternate embodiments, the histogram 600 and/or active bid table 700 may be stored as one or more flat files in the RAM of a server that hosts the automated bid proxy 100. In alternate embodiments, the histogram 600 and/or active bid table 700 may be stored in the automated bid proxy 100 as one or more XML files, two tables in a relational database, one or more data structures in the RAM of the server, or in any other suitable format at any other suitable location. Processing flow may then continue to step 510, where operation of the bid count module 302 ends.

In an alternate embodiment, the bid table 200 may be managed by a relational database management system (RDBMS). Rather than loading the bid table 200 into memory, the bid count module 302 may access the bid table 200 through the RDBMS, such as by issuing SQL queries to the RDBMS and receiving responses to those queries from the RDBMS.

Generally and throughout this disclosure, it should be appreciated that any explicit reference to loading something into or allocating a region of memory that is associated with an instance of a module may imply that there exists an alternate embodiment in which an RDBMS may be employed in a manner analogous to that just described hereinabove in relation to the bid table 200.

Referring now to FIG. 8, a histogram 600 may include rows relating a perfect bid time (PERFECT_BID) to a bin count (BIN_COUNT) of the number of future bids in the bid table 200 that are associated with the perfect bid time. The perfect bid time may represent the time at which a future bid would be executed, if it could be executed in perfect accordance with the values that define it in the bid table 200. The perfect bid time may be determined by adding an AUCTION_END value to its related BID_TIME value. PERFECT_BID may be a primary key.

In an embodiment, an approximately 45-second range of PERFECT_BID values may be included in the histogram 600. This range may be defined to be between 90 and 120 seconds in the future at the time that the histogram 600 is created. By defining the range in this way, an embodiment of the invention is allowed to process a 45-second set of future bids, 90 to 120 seconds in advance of when the first bid in the set would, in a perfect world, be executed. The size of this range, 45 seconds, may define the period of the time to dynamically adjust bids, which is described hereinabove with reference to FIG. 6. Every bid in the bid table 200 that is associated with a PERFECT_BID value that is within the range may be represented in the histogram 600.

A bin count is a literal indication of the number of bids that would ideally be placed at a future time. Since placing a bid may impart some load on the automated bid proxy 100, the bin count may be a predictor of the load that might be on the automated bid proxy 100 at the future time. Thus, generally speaking, a predicted load on the automated bid proxy 100 may be proportional to a bin count in the histogram 600.

Referring now to FIG. 9, an active bid table 700 may contain a set of BID_ID values. These BID_ID values may be those of the bids that are represented in the histogram 600.

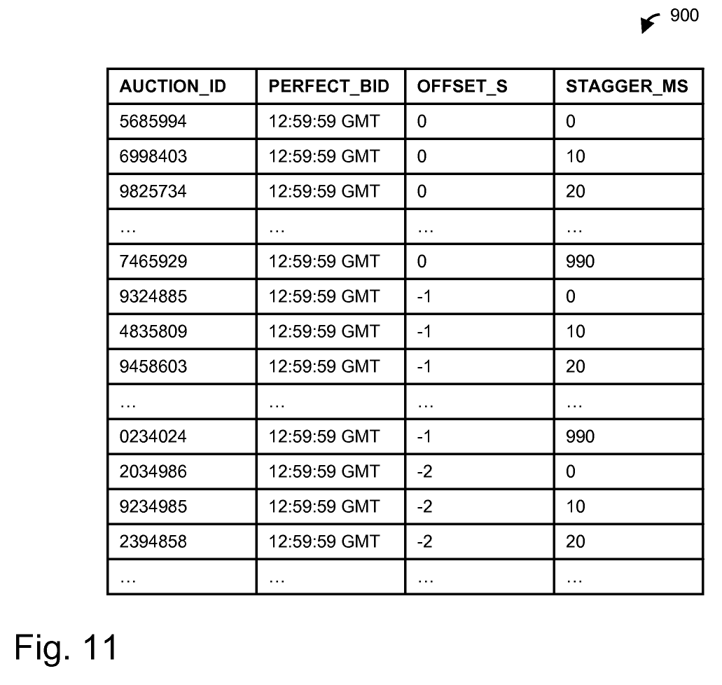

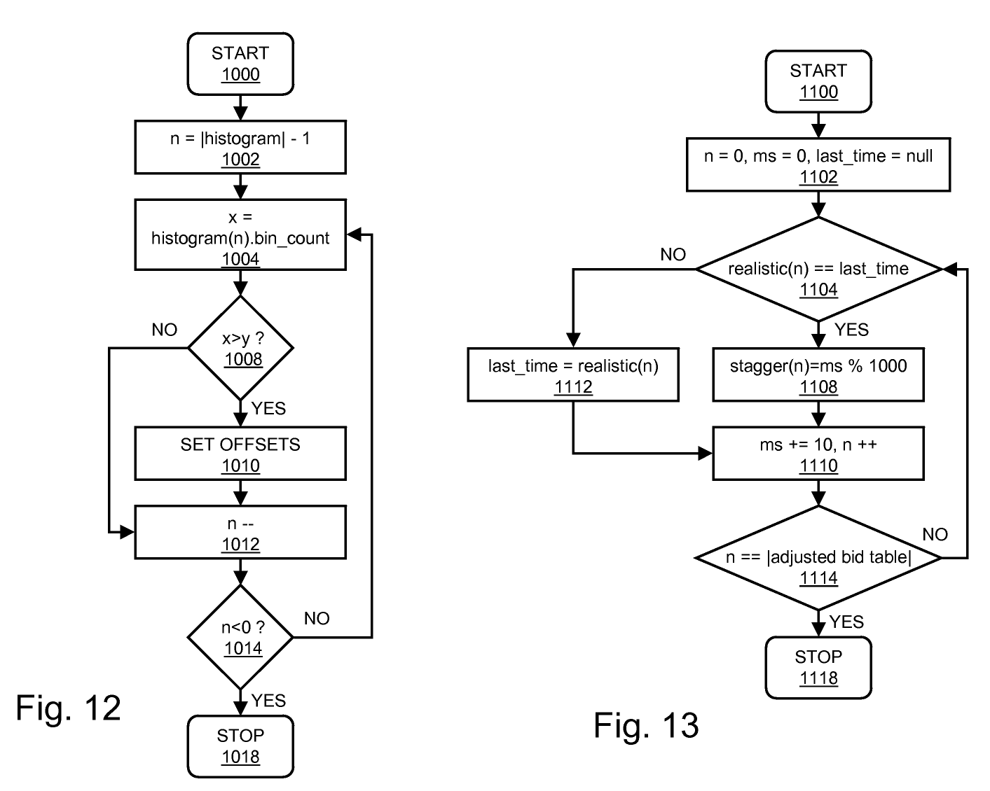

Referring now to FIG. 10, operation of an embodiment of the bid queue module 304 may start at logical control block START 800. From there, processing flow may continue to step LOAD BIDS 802, where the bid table 200 may be loaded into a region of memory associated with and accessible to the instance of the bid queue module 800. Next, processing flow may continue to step LOAD HISTOGRAM AND ACTIVE BID TABLE 804, where the histogram 600 and the active bid table 700 may be loaded into a region of memory associated with and accessible to the instance of the bid queue module 800. Then, processing flow may continue to step MAKE ADJUSTED BID TABLE 808, where a region of memory associated with and accessible to the instance of the bid queue process 800 may be allocated for the purposes of storing an adjusted bid table 900. An example of the adjusted bid table 900 is described in detail hereinafter with reference to FIG. 11. Processing flow may proceed to step ADJUST BIDS 810. Here a bid offset value may be calculated for each of the bids in the bid table 200 that is represented in the histogram 600. An example of the bid offset value is described in detail hereinafter with reference to FIG. 11. An example of a method for calculating the bid offset value is described in detail hereinafter with reference to FIG. 12. Next, processing flow may continue to step STAGGER BIDS 812, where a bid stagger value may be calculated. An example of the bid stagger value is described in detail hereinafter with reference to FIG. 11. An example of a method for calculating the bid stagger value is described in detail hereinafter with reference to FIG. 13. Next, processing flow may continue to step LAUNCH EXECUTE BID 814, where a BID_ID value in the active bid table 700 that has not already been associated with an instance of the bid execute module 308 may be associated with a new instance of the bid execute module 308. This instance of the bid execute module 308 may receive as parameters some or all of the values in the adjusted bid table 900 that may be associated with the BID_ID value. Processing flow may then proceeds to step 818, where a test may determine whether there is a BID_ID value in the active bid table 700 that has not been associated with an instance of the bid execute module 308. If the result of this test is affirmative, the process flow may return to step 814. Otherwise, the process flow may proceed to step STOP 820, where the process may end.

Referring now to FIG. 11, an adjusted bid table 900 may include entries relating the AUCTION_ID, the PERFECT_BID, the bid offset value (OFFSET_S), and the bid stagger value (STAGGER_MS). The bid offset value may be represented in whole seconds and the bid stagger value may be represented in whole milliseconds. The rows in the adjusted bid table 900 may be representative of the future bids contained in the active bid table 700. By default, all bid offset values and bid stagger values may initially be set to zero.

For purposes of illustration and not by way of limitation, the rows of the adjusted bid table 900 are sorted both in ascending order based upon the bid stagger values in the STAGGER_MS fields and in descending order based upon the bid offset values in the OFFSET_S field. The bid offset method 1000 and the bid stagger method 1100, as described hereinafter with references to FIG. 12 and FIG. 13, depend upon the rows being sorted as described.

Those of ordinary skill in the art will appreciate that the rows of the adjusted bid table 900 need not be sorted, or may be sorted according to any ad hoc or other method, so long as appropriate modifications are applied to the bid offset method 1000 and/or the bid stagger method 1110. Thus, the particular arrangement of the rows in the adjusted bid table 900 and detailed descriptions of the bid offset method 1000 and the bid stagger 1100 method are provided for the purposes of illustration only, and should not be understood to limit the scope of the systems described herein.

The bid offset value may represent a delta between a perfect bid time and a realistic bid time. The realistic bid time may be a time or an estimate of a time at which the automated bid proxy 100 may realistically be able to place an associated bid. The bid stagger value may represent a delta between the realistic bid time and the actual time at which the bid may be placed. When applied to the perfect bid times, the bid stagger values and the bid offset values have the effect of spreading the actual bid times both across seconds and within seconds. By spreading bids in this manner, the loads imposed on the automated bid proxy 100 (and on the online auction system 104, for that matter) may be spread out over time, thus avoiding an overload condition that could have develop were the loads were not spread out. While the systems and methods described herein emphasize distribution of bids in a manner appropriate to the capacity of the automated bid proxy 100, it will be understood that the bid distribution may also or instead be adapted according to the capacity of the online auction system 104, which may vary from auction platform to auction platform. In other embodiments, the bid distribution may take account of anticipated or actual network traffic according to time of day, reported network statistics, and so forth, as well as other users of the online auction system 104, or other automated bidding systems, and the like, any of which may be measured or reported, or some combination of these. More generally, however determined, once an appropriate distribution of bids in a group is determined, bids may be executed accordingly using the techniques described herein.

Referring to FIG. 12, a method for calculating the bid offset value is shown. This method modifies some or all of the bid offset values in the adjusted bid table 900 based on the contents of the histogram 600. The method may begin at the step START 1000. From there, processing flow may continue to step 1002, where a variable n is set to the number of rows in the histogram 600 minus l. Processing flow may continue to step 1004, where a variable x is set to the count in of the n^{th} row of the histogram. Then, processing flow may continue to step 1008, where a test determines whether the value of x is greater than a value y. The value of y may represent a threshold above which an offset may be applied to some bids. In an embodiment, y may be 30. If the result of the test in step 1008 is affirmative, processing flow may proceed to step 1010. If not, processing flow may proceed to step 1012. At step 1010, bid offset values may be assigned to the bids that are represented in the n^{th} row of the histogram 600. Each of these bid offset values may be written to a row in the adjusted bid table 900 that is associated with a bid that is represented in the n^{th} row of the histogram, with one bid offset value being written to each of the represented bids. The bid offset values may be selected so that no more than q of the represented bids will have the same realistic bid time, where q may be a threshold value. In addition, the bid offset values may be selected so that the realistic bid times are as close to the perfect bid times as possible, without being later than the perfect bid times. In an embodiment q may be 300.

Referring now to FIG. 13, a method for calculating the bid stagger value is shown. This method may modify some or all of the bid stagger values in the adjusted bid table 900 based on the contents of the adjusted bid table 900. The method may begin at the step START 1100. From there, processing flow may continue to step 1102, where a variable n is set to 0, a variable ms is set to 0, and a variable last_time is set to null. Next, processing flow may continue to step 1104, where a test may determine whether the realistic bid time of the bid represented by the n^{th} row of the adjusted bid table 900 is equal to the value of last_time. If the result is negative, processing flow may proceed to step 1112, where last_time may be set to the realistic bid time of the bid represented by the n^{th} row of the adjusted bid table 900. From here, processing flow may continue to step 1110. However, if the result of the test in step 1104 is affirmative, processing flow may proceed from there to step 1108. Here, the bid stagger value in the n^{th} row of the adjusted bid table 900 may be set to ms modulo 1000. Next, processing flow may proceed to step 1110, where the value of ms may be increased by 10 and where n may be incremented. Processing flow may proceed to step 1114, where a test may determine whether n is equal to the number of rows in the adjusted bid table 900. If the result of the test is affirmative, processing flow may proceed to step 1118, where the method ends. Otherwise, processing flow may return to step 1104.

Referring now to FIG. 14, a method of the bid execute module 308 is shown. Recall that an instance of the bid execute module 308 may receive as parameters the values in the adjusted bid table 900 that are associated with a bid. In particular, the bid execute module may receive as parameters a unique auction identifier, a perfect bid time, a bid offset value, and a bid stagger value. The process may start at step 1200. From there, processing flow may continue to step 1202, where the method may wait until a time of day equals the perfect bid time plus the bid offset value plus the bid stagger value. Then, processing flow may proceed to step 1204, where a test may determine whether the bid still exists in the bid table 200. If the test produces an affirmative result, then processing flow may proceed to step 1208, where a bid associated with the unique auction identifier may be transmitted to the online auction system 104. Otherwise, processing flow may proceed to step 1210 where the bid execute module may halt.

Referring now to FIG. 15, a process 1300 for updating the bid group table 250 and removing bids from the bid table 200 is depicted. The process 1300 starts at step 1302. Processing flow continues to step 1304, where the bid proxy 100 may receive a signal from the online auction system 104, the signal indicating that a bid that was transmitted to the online auction system 104 (such as the bid that may be transmitted in step 1208 of FIG. 14) is a winning bid. Processing flow may continue to step 1308, where the proxy 100 updates the bid group table 250 by incrementing the value of ACTUAL_WIN that is associated with the GROUP_ID that is associated with the winning bid. Next, a test at step 1310 may check the values of ACTUAL_WIN and TARGET_WIN that are associated with the GROUP_ID for equality. If the test is affirmative, processing flow may continue to step 1312 where the proxy 100 removes all of the remaining bids (i.e. rows) in the bid table 200 that contain that GROUP_ID. When possible, the proxy may also cancel any and all of those bids that already have been transmitted and are not yet winning bids so as to prevent those bids from winning. Next, processing flow may proceed to step 1314 where this process ends. Likewise, if the result of the test at step 1310 is negative then the logical flow may proceed from there directly to step 1314.

It will be appreciated that the timing of the bid may have been dynamically adjusted by the methods and systems described hereinabove. As a result, the peak load that is actually experienced by the automated bid proxy 100 may be less than it would have been had the timing of the bid not been dynamically adjusted.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1 A method comprising:
receiving a user specification of a group bid for an item, the group bid including a total number of bids to be placed, a target number of winning bids; and a preferred bid time;
creating a bid schedule including a plurality of bids each having a bid time, wherein the plurality of bids allocate the total number of bids over a time period selected to ensure that bid placement does not exceed a capacity of an automated bid proxy and selected to ensure that the total number of bids can be placed on or before the preferred bid time; and
submitting the plurality of bids from the automated bid proxy to an online auction system at the bid times specified in the bid schedule.

2. The method of claim 1 further comprising terminating the step of submitting the plurality of bids when the target number of winning bids has been achieved.

3. The method of claim 1 further comprising cancelling any remaining bids in the bid schedule when the target number of winning bids has been achieved.

4. The method of claim 1 further comprising allocating the plurality of bids in the bid schedule over a time period selected to ensure that bid placement does not exceed a capacity of the online auction system.

5. The method of claim 1 further comprising allocating the plurality of bids in the bid schedule over a time period selected to ensure that bids from the automated bid proxy to the online auction system arrive at the online auction system at or before the preferred bid time.

6. The method of claim 1 further comprising submitting bids to a plurality of online auction systems for the item.

7. The method of claim 1 wherein the user specification includes a bid price.

8. The method of claim 1 wherein the user specification includes a range of bid prices.

9. The method of claim 1 further comprising determining the bid schedule using a histogram that characterizes a time distribution for bids.

10. The method of claim 9 further comprising staggering the total number of bids to be placed over a time interval according to the histogram.

11. The method of claim 1 further comprising adjusting each one of the bid times by an offset.

12. The method of claim 11 wherein the offset accounts for one or more of network latency and network traffic.

13. The method of claim 11 wherein the offset accounts for a measured network performance.

14. The method of claim 11 wherein the offset accounts for an anticipated network performance.

15. A computer program product embodied in computer executable code that, when executing on one or more computing devices, performs the steps of:
receiving a user specification of a group bid for an item, the group bid including a total number of bids to be placed, a target number of winning bids; and a preferred bid time;
creating a bid schedule including a plurality of bids each having a bid time, wherein the plurality of bids allocate the total number of bids over a time period selected to ensure that bid placement does not exceed a capacity of an automated bid proxy and selected to ensure that the total number of bids can be placed on or before the preferred bid time; and
submitting the plurality of bids from the automated bid proxy to an online auction system at the bid times specified in the bid schedule.

16. The computer program product of claim 15 further comprising computer executable code that performs the step of submitting the plurality of bids when the target number of winning bids has been achieved.

17. The computer program product of claim 15 further comprising computer executable code that performs the step of cancelling any remaining bids in the bid schedule when the target number of winning bids has been achieved.

18. The computer program product of claim 15 further comprising computer executable code that performs the step of staggering the total number of bids to be placed over a time interval according to a histogram that characterizes a time distribution for bids.

19. The computer program product of claim 15 further comprising computer executable code that performs the step of adjusting each one of the bid times by an offset.

20. The computer program product of claim 19 wherein the offset accounts for one or more of network latency and network traffic.
